(19) United States
(12) Patent Application Publication
(10) Pub. No.: US 2008/0188194 A1
(43) Pub. Date: Aug. 7, 2008

(54) SERVICE QUALITY INDICATION ON A WIRELESS DEVICE

(75) Inventor: Huitao Liu, Austin, TX (US)

Correspondence Address: ZAGORIN O'BRIEN GRAHAM LLP (037), 7600B NORTH CAPITAL OF TEXAS HIGHWAY, SUITE 350, AUSTIN, TX, 78731-1191, US

(73) Assignee: CINGULAR WIRELESS II, LLC, Atlanta, GA (US)

(21) Appl. No.: 11/671,780

(22) Filed: Feb. 6, 2007

(51) Int. Cl. H04B 17/00; H04B 1/10

(52) U.S. Cl. 455/226.4; 455/226.2

(57) ABSTRACT

A wireless device determines signal quality for a wireless signal according to both the received signal strength of the received wireless signal and the signal to interference ratio of the received wireless signal. The wireless device provides a signal quality indication corresponding to the determined signal quality to a user of the wireless device, e.g., on a display of the wireless device.

### BACKGROUND

1. Field of the Invention

This application relates to wireless devices and more particularly to determining quality of a received signal in a wireless device.

2. Description of the Related Art

Wireless devices such as cell phones have provided a user with an indication of a received signal quality that corresponds to the strength of the received signal. However, for CDMA and wideband CDMA systems, the strength of the received signal may not be as good an indicator of signal quality as for previous types of wireless systems. Accordingly, an improved approach to indicating signal quality is desirable.

### SUMMARY

In one embodiment of the invention, a method is provided that includes determining a signal quality for a wireless signal received by a wireless device according to a signal strength and a signal to interference ratio of the received wireless signal. The wireless device provides a signal quality indication corresponding to the determined signal quality to a user of the wireless device. The signal quality indication may be provided on a display of the wireless device. In an embodiment, the wireless device compares the received signal strength to a signal strength threshold value and then determines the signal quality according to the received signal to interference ratio.

In another embodiment, a wireless device includes a wireless receiver operable to receive a wireless signal. The wireless device is operable to determine a signal quality for the wireless signal according to a received signal strength of the wireless signal and a signal to interference ratio of the wireless signal. The wireless device also includes a user interface operable to provide a signal quality indication corresponding to the determined signal quality. The wireless device may also include a display in the user interface configured to display the signal quality indication. In an embodiment the wireless device is further operable to compare the received signal strength to a signal strength threshold value and then determine the signal quality according to the received signal to interference ratio.

### BRIEF DESCRIPTION OF THE DRAWINGS

The present invention may be better understood, and its numerous objects, features, and advantages made apparent to those skilled in the art by referencing the accompanying drawings.

FIG. 1 depicts a block diagram of an exemplary cell phone system.

FIG. 2 depicts an exemplary mobile device supplying a service quality indication.

FIG. 3 depicts an exemplary flow diagram illustrating the major steps of an embodiment of the invention performed by a mobile device such as illustrated in FIGS. 1 and 2.

The use of the same reference symbols in different drawings indicates similar or identical items.

### DESCRIPTION OF THE PREFERRED EMBODIMENT(S)

Wireless devices, such as cell phones, have typically used a visual indication, e.g., a number of bars, in the user interface (e.g., the handset display) to present to the user a visual indication of the quality of the received signal. As stated earlier, a typical basis for the visual indication has been received signal strength. The visual indication can give a user an indication of service quality and availability both in idle mode and during an active service session (voice, data, etc.). Typically, more bars indicate a better signal, which is an indication of better service. Signal quality is important to a wireless carrier's reputation in terms of coverage and quality.

Most wireless devices map the received signal strength to the number of bars directly. For example, a GSM (Global System for Mobile Communications) handset may display full bars when the received signal level on the broadcast control channel (BCCH) is above a certain level, such as −70 dBm. The number of bars displayed will gradually decrease as the received signal strength becomes weaker. In general, this is acceptable as a service quality indication for air interface technologies using narrow band frequency division duplex (FDD) signals, since each channel is defined by a certain width of the radio frequency. Even though the channels are also sometimes shared among users in the frequency domain, there is only one user using a specific channel at any given time.

However, this is no longer the case in a code division multiple access (CDMA) systems. In a CDMA system, all users in the network share the RF channel. The users are no longer separated in the time domain and the frequency domain. Instead, they are separated in the code domain. In a CDMA system, interference from other users using the same RF channel, but different orthogonal or spreading codes in both the serving cell and neighboring cells, has a large impact on service quality and availability. The received signal strength only impacts the service when it is very close to the limit of the receiver sensitivity of the device. In a CDMA system, because of the processing gain and orthogonality of the codes, even with very low signal strength the quality of user services will not degrade dramatically, as long as the signal to interference ratio is above the quality of service requirement and the received signal strength of the useful signal is higher than the receiver sensitivity. Assume, for example, in a CDMA system that a receiver applies code C1 to a signal composed of five codes C1 to C5. Theoretically, applying the code C1 yields a 0 value for all codes not C1 since the codes are orthogonal. However, there are trailing effects, losses, noise due to imperfect orthogonality, if, e.g., delays are introduced, and the sum of all the energy transmitted in all the code segments forms essentially a noise floor over which the signal must be detectable.

In a CDMA system, information to be transferred from a Base Transceiver Station (BTS) to user equipment (e.g., a cell phone) is originally narrowband. An encoder in the transmitter transforms this into a wideband, low energy signal, spreading the energy. At the receiver the code is used to despread the signal transforming back into a narrowband high energy signal to be interpreted.

For CDMA and WCDMA systems, a better indication of signal quality can be provided by using a weighted combination of the signal to interference ratio and a received signal strength indication, which may be received signal code power (RSCP), to map to the quality indication in the user interface, thus giving the user a more accurate presentation of the quality and availability of the service. That means the user perception of the service will be more accurate. Note that the signal to interference ratio is defined herein as the ratio of the power of the received desired signal to the total power of all other interfering (undesired) signals and noise, although other definitions for signal to interference ratio may be suitable as well and used according to the teachings herein.

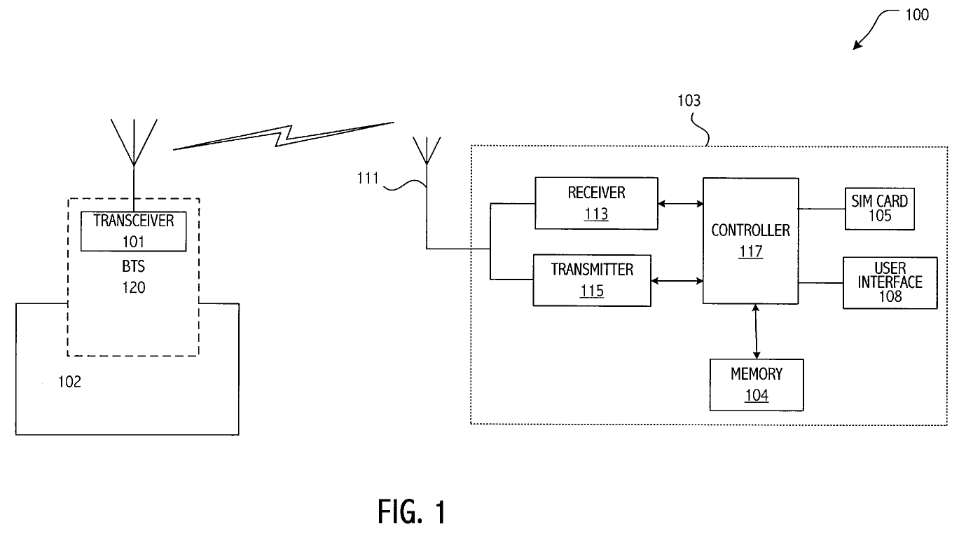

FIG. 1 depicts a block diagram of an exemplary cell phone system that includes the capability of displaying a signal quality indication based on both a signal strength indication, such as an RSCP of the signal and the signal to interference ratio associated with the signal. FIG. 1 shows a wireless system 100 with a mobile device 103 and a base transceiver station BTS 120 having a cellular antenna transceiver 101 in communication with a mobile device 103. Note that the present invention may be used advantageously in multiple types of mobile telecommunications systems 100. For example, while the invention is described herein contemplating use in CDMA and WCDMA systems, the invention may also be useful in time division multiple access (TDMA) systems (such as GSM) where the interference may be co-channel interference from users in adjacent cells. In fact the invention described herein may be beneficial in RF communication systems generally wherever the signal to interference ratio may be used in combination with received signal strength to indicate quality of a received signal.

The components of the mobile device 103 are known in the art, although functionally some of those components are modified or enhanced as described herein with respect to the present invention. The mobile device 103 includes an antenna 111 coupled to receiver 113 for receiving radio frequency transmission signals from/to the BTS 120. The mobile device 103 includes a controller 117, such as a microprocessor, microcontroller or similar data processing device that executes program instructions stored in a memory 104. The cellular antenna transceiver 101 is typically operated in one or more sectors 102.

The memory 104 may be implemented using any appropriate combination of alterable, volatile or non-volatile memory or non-alterable, or fixed memory. The alterable memory, whether volatile or non-volatile, may be implemented using any one or more of static or dynamic RAM, a floppy disk and disk drive, a writable or re-writable optical disk and disk drive, a hard drive, flash memory or other alterable memory components known in the art. Similarly, the non-alterable or fixed memory may be implemented using any one or more of ROM, PROM, EPROM, EEPROM, an optical ROM disk, such as a CD-ROM or DVD-ROM disk, and disk drive or other non-alterable memory known in the art.

The controller 117 may be implemented as a single special purpose integrated circuit (e.g., ASIC) having a main or central processor unit for overall, system-level control, and separate sections dedicated to performing various specific computations, functions and other processes under the control of the central processor unit. The controller 117 can also be implemented as a single microprocessor circuit, DSP, or a plurality of separate dedicated or programmable integrated or other electronic circuits or devices, e.g., hardwired electronic or logic circuits such as discrete element circuits or programmable logic devices. The controller 117 may also include other circuitry or components, such as memory devices, relays, mechanical linkages, communications devices, drivers and other ancillary functionality to affect desired control and/or input/output functions.

The controller 117 is operatively coupled with user interface 108. The user interface 108 may include items known in the art, such as a display, keypad, speaker, microphone, and other user interface I/O components. In an embodiment of the invention, the controller is adapted according to the teachings herein to control the display of the signal quality in the display portion of the user interface 108. The controller 117 also controls interfaces with a SIM card 105 during operation of the mobile device 103. As is known in the art, the SIM card 105 typically stores information relating to the user, such as subscribed features, attributes, identification, account and other information that customizes a mobile device 103 for a typical user. The controller 117 controls and/or monitors the operations of the transmitter 115 that transmits radio frequency (RF) signals to the cellular antenna transceiver 101 of a base station via the antenna 111 coupled to the mobile device 103. The controller 117 is operatively connected to antenna receiver 113, which may be conventional.

In an embodiment, the receiver 113 determines the signal strength (RSCP or other measurement) and the signal to interference ratio of the received signal and provides that information to the controller 117. In other embodiments, those determinations are made by the receiver in conjunction with other functionality. For example, some of the signal processing functionality utilized to determine the signal strength and the signal to interference ratio may be performed in the controller 117 or other DSP functionality coupled to receiver 113. Both the signal strength and the signal to interference ratio are utilized by the controller 117 to determine an appropriate signal quality indication. Based on this signal quality, a signal quality indication is selected, and control information is sent to the display device in the user interface 108 to display the selected signal quality indication.

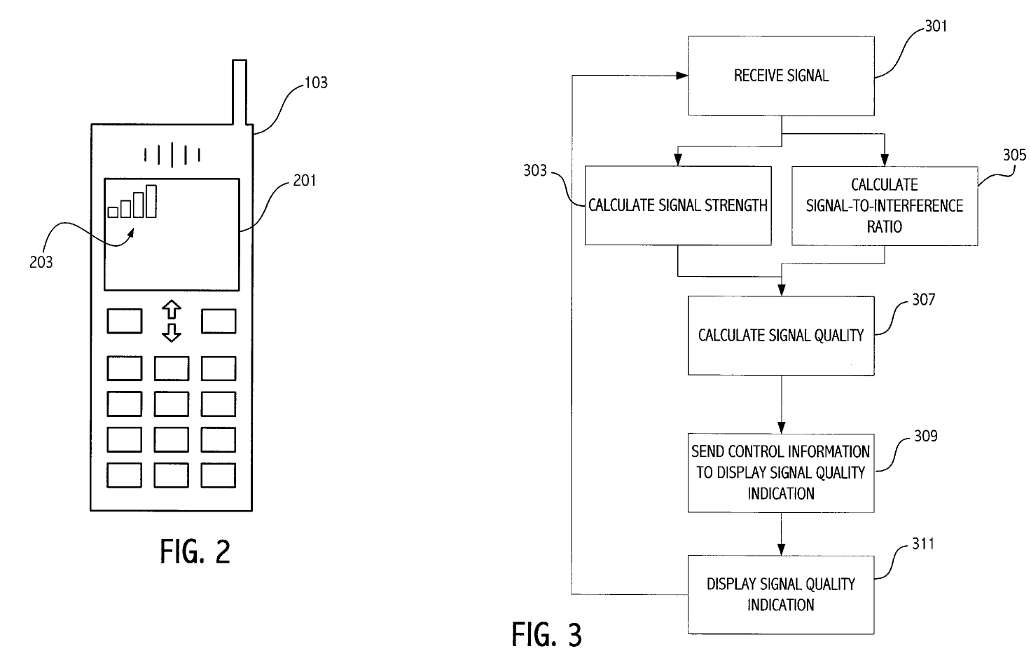

Referring to FIG. 2, an exemplary mobile device 103 is shown with the display device 201 of user interface 108 shown more clearly. The user interface includes a display screen 201 that provides a signal quality indication 203 composed of four (or fewer) bars. The number of bars displayed is dependent upon both the received signal strength (e.g., RSCP) and the signal to interference ratio as described more fully below.

Note that while the quality indication in FIG. 2 is shown as a number of bars, many other quality indications are possible including text, numerals, or any number of icons or colors, or a combination of various indicators to indicate to a user of the cell phone the quality of the signal being received. For the embodiment in which a variable number of bars are displayed to indicate signal quality, each bar may be displayed or not according to the determined signal quality. In some embodiments, more granular quality indications may cause portions of a bar or bars to be visible. In other instances, the signal quality indication may be a series of icons, and the characteristic determined by the signal quality could determine one or more aspects of the icon. In still other cases, a single icon may be displayed in different colors determined by the signal quality, such as red for poor, yellow for acceptable, and green for excellent. Other characteristics of the signal quality indication may be the location of a set of pixels arranged in a triangular or curved pattern, the length of a bar, or the brightness of an icon or region of the display device. Note that the signal quality indication may also be audio rather than visual, or even tactile. Thus, regardless of the type of the signal quality indication, one or more characteristics of the signal quality indication may be determined by the value of the signal quality determined according to the various embodiments of the invention described herein.

Signal quality for idle and active modes may be calculated in the same way, but may have different actual values. In idle mode the base transceiver station 120 (see FIG. 1) transmits a constant power signal over the Common Pilot Channel (CPICH). The handset in idle mode can use this signal to measure the received signal strength and the signal to interference ratio.

The pseudo code example below illustrates how the signal quality indication may be determined using the received signal strength and the signal to interference ratio for operation in idle mode. The comparisons may be performed in the controller 117 using appropriate comparison software or done in hardware or in a combination of hardware and software. The threshold levels for the RSCP (corresponding to receiver sensitivity and offsets to the receiver sensitivity) may be stored in the memory 104 along with the various value ranges for the signal to interference ratio and appropriate comparison software. In the following example, the RSCP is used for the received signal strength.

```
If RSCP > (receiver sensitivity + 3dB) then
  If signal to interference ratio > −5dB then display 4 bars;
  If −5dB > signal to interference ratio > −10dB then display
    3 bars;
  If −10dB > signal to interference ratio > −15dB then
    display 2 bars;
  If −15dB > signal to interference ratio > −20dB then
    display 1 bar;
  If −20dB > signal to interference ratio then display 0
    bars;
If (receiver sensitivity + 3dB) > RSCP > receiver sensitivity
    then
  If signal to interference ratio > −5dB then display 3 bars;
  If −5dB > signal to interference ratio > −10dB then display
    2 bars;
  If −10dB > signal to interference ratio > −15dB then
    display 1 bar;
  If −15dB > signal to interference ratio then display 0 bars;
```

As can be seen, if the received signal strength is above a threshold (here receiver sensitivity+3 dB), the received signal strength is assumed not to impact the quality of service significantly. Instead, the quality of service is determined according to the signal to interference ratio. Note that if the received signal strength is below the receiver sensitivity, 0 bars are displayed. However, if the received signal strength is below the threshold but still above the receiver sensitivity, the number of bars is reduced as the signal strength has impact on quality of service to 3 even for the highest signal to interference ratio.

In active mode, a channel is dedicated to the handset. There is a target Ec/No, which is a ratio of signal power to noise spectral density times bandwidth, for both downlink and uplink. The value of the true Ec/No is compared to the target at a rate of about 1.5 KHz and the transmitted energy is adjusted. Thus, in active mode it may be more accurate to rely on the handset's received power in the dedicated channel rather than the CPICH. Note that the threshold values for active mode may be similar to the above example for idle mode and dependent upon the particular system.

In general terms, a signal quality may be assigned to the received signal based on the strength of the signal and the signal to interference ratio associated with the signal. In the first example, an integer signal quality may be assigned depending on the comparison of the received signal strength to the sensitivity of the receiver and of the signal to interference ratio to a predetermined range of values for the signal to interference ratio. The value of the signal quality, in the example from 0 to 4, may then determine a characteristic of the signal quality indication. In one embodiment shown, the signal quality indication is a set of four bars, and its characteristics may be the number of bars displayed, with four bars indicating the highest signal quality and no bars indicating a level of service that does not permit effective communication of voice, data, or both. The pre-assigned ranges may be arbitrarily small, allowing for fine gradations in the signal quality indication, for example to show a curve using pixels as units rather than bars, or to show gradual gradations in color of a bar or other icon.

In another embodiment, the total number of bars displayed may be determined as follows:

Quality indication displayed=(maximum quality indication)×weighted relative received signal strength level (RSCP compared to receiver sensitivity)+weighted signal to noise/interference ratio).

In this embodiment, a signal quality may be calculated by constructing a weighted combination of signal strength and signal to interference ratio. The quality indication displayed, e.g., number of bars displayed, may then be the maximum quality indication, e.g., four bars, multiplied by the signal quality. Many weighted combinations are possible and the particular weighting used may depend upon the particular wireless implementation.

Note that while the discussion herein focuses primarily on cell phone user interfaces and particularly displays, the invention is applicable to a wide variety of wireless devices, such as pagers, personal digital assistants (PDAs), and wireless data cards used in personal computers. The various devices may use different display mechanisms to present signal quality indications. For example, wireless data cards may transmit a value for signal quality to a personal computer which then displays a textual message or other graphic indicating the signal (hence service) quality, while pagers and telephones may use the length of a single bar (or other mechanism) to indicate the signal quality.

Referring to FIG. 3, an exemplary flow chart illustrates the overall process for an embodiment of the invention. In 301 the handset receives the signal. In 303 and 305, the handset determines the signal strength and the signal to interference ratio. Based on the signal strength and signal to interference ratio, the signal quality is determined in 307 and appropriate control information for the display corresponding to the signal quality is determined in 309. The display then displays the signal quality indication according to the control information in 311. The flow then returns again to receive the signal in 301. The process may be repeated according to the needs of the particular wireless system in order to provide accurate quality information to the user.

The foregoing detailed description has described only a few of the many possible implementations of the present invention. For this reason, this detailed description is intended by way of illustration, and not by way of limitation. Variations and modifications of the embodiments disclosed herein may be made based on the description set forth herein, without departing from the scope and spirit of the invention. It is only the following claims, including all equivalents, which are intended to define the scope of this invention. Accordingly, other variations, modifications, additions, and improvements may fall within the scope of the invention as defined in the claims that follow.

What is claimed is:

1. A method comprising:
determining a signal quality for a wireless signal received by a wireless device according to a received signal strength and a signal to interference ratio of the received wireless signal; and
providing a signal quality indication corresponding to the determined signal quality to a user of the wireless device.

2. The method as recited in claim 1 further comprising providing the signal quality indication on a display of the wireless device.

3. The method of claim 2, wherein providing the signal quality indication includes displaying a variable number of bars according to the signal quality.

4. The method as recited in claim 1 further comprising comparing the received signal strength to a signal strength threshold value and then determining the signal quality according to the received signal to interference ratio.

5. The method as recited in claim 4 wherein determining the signal quality according to the received signal to interference ratio further comprises:
comparing the signal to interference ratio to a set of predetermined value ranges; and
determining the signal quality to correspond to a particular one of the value ranges into which the signal to interference ratio falls.

6. The method as recited in claim 4 wherein if the received signal strength is a predetermined amount above receiver sensitivity, then determining the signal quality indication to be in a range from a minimum signal quality indication to a maximum signal quality indication according to the signal to interference ratio.

7. The method as recited in claim 4 wherein if the received signal strength is below a predetermined amount above receiver sensitivity and above the receiver sensitivity, then determining the signal quality indication to be in a range from a minimum signal quality indication to a less than maximum signal quality indication according to the signal to interference ratio.

8. The method as recited in claim 4 further comprising monitoring a control channel in idle mode and a different channel in active mode to determine the received signal strength and the signal to interference ratio.

9. The method as recited in claim 1 further comprising determining the signal quality using a weighted combination of the signal strength and the signal to interference ratio.

10. The method of claim 1, wherein providing the signal quality indication comprises:
determining a signal quality indication characteristic, at least in part, according to the determined signal quality, the signal quality indication characteristic comprising at least one of a color, a length, a number of units, a brightness, a location, and a shape; and
displaying the signal quality indication according to the determined characteristic.

11. A wireless device comprising:
a wireless receiver operable to receive a wireless signal; and
wherein the wireless device is operable to determine a signal quality for the wireless signal according to a received signal strength and a signal to interference ratio of the wireless signal.

12. The wireless device as recited in claim 11 further comprising a user interface operable to provide a signal quality indication corresponding to the determined signal quality.

13. The wireless device as recited in claim 12 wherein the user interface comprises a display coupled to display the signal quality indication.

14. The wireless device as recited in claim 11 wherein the wireless device is further operable to compare the received signal strength to a signal strength threshold value and then determine the signal quality according to the received signal to interference ratio.

15. The wireless device as recited in claim 14 wherein if the signal strength is a predetermined amount above receiver sensitivity, then the signal quality is determined to be in a range from a minimum signal quality indication to a maximum signal quality indication according to the signal to interference ratio.

16. The wireless device as recited in claim 14 wherein if the signal strength is below a predetermined amount above receiver sensitivity and above the receiver sensitivity, then the signal quality is determined to be in a range from a minimum signal quality to a less than maximum signal quality indication according to the signal to interference ratio.

17. The wireless device as recited in claim 11 wherein the wireless device is operable to monitor a control channel in idle mode to determine the received signal strength and the signal to interference ratio and a different channel in active mode to determine the received signal strength and the signal to interference ratio.

18. The wireless device as recited in claim 11 wherein the wireless device is operable to determine the signal quality using a weighted combination of the signal strength and the signal to interference ratio.

19. The wireless device as recited in claim 11, further comprising:
a storage holding a set of predetermined range of values for signal to interference ratio; wherein
the wireless device is operable to compare the signal to interference ratio to the set of the predetermined range of values for the signal quality; and
wherein the signal quality is determined to correspond to a particular one of the range of values into which the signal to interference ratio falls.

20. A wireless device comprising:
means for determining a signal quality for a wireless signal received by a wireless device according to a received signal strength and a signal to interference ratio of the received wireless signal; and
a user interface coupled to provide a signal quality indication corresponding to the determined signal quality to a user of the wireless device.
